(19) United States
(12) Patent Application Publication
(10) Pub. No.: US 2016/0312912 A1
(43) Pub. Date: Oct. 27, 2016

(54) ELECTROMAGNETIC VALVE AND BRAKE UNIT

(71) Applicant: HITACHI AUTOMOTIVE SYSTEMS, LTD., Hitachinaka-shi, Ibaraki (JP)

(72) Inventors: Chiharu NAKAZAWA, Kawasaki-shi (JP); Masaki MISUNO, Atsugi-shi (JP)

(73) Assignee: HITACHI AUTOMOTIVE SYSTEMS, LTD., Hitachinaka-shi, Ibaraki (JP)

(21) Appl. No.: 15/102,148

(22) PCT Filed: Dec. 3, 2014
(86) PCT No.: PCT/JP2014/081933

§ 371 Date: Jun. 6, 2016

(30) Foreign Application Priority Data
Dec. 12, 2013 (JP) 2013-256959

(51) Int. Cl. F16K 31/06; B60T 11/28; B60T 13/68; B60T 11/16

(52) U.S. Cl. CPC F16K 31/0655; B60T 11/165; B60T 11/28; B60T 13/686

(57) ABSTRACT

An object of the present invention is to provide an electromagnetic valve and a brake unit capable of improving controllability while leading to no or a less increase in the size and no or less deterioration of the efficiency. An electromagnetic valve includes a movable element configured to close a flow passage by abutting against a seat portion when being not actuated, a stator disposed at a position in an axial direction of the movable element, a coil configured to generate an electromagnetic force so as to cause a stroke of the movable element in a direction away from the seat portion, and a plate-shaped spring member configured to bias the movable element toward the seat portion.

### TECHNICAL FIELD

The present invention relates to an electromagnetic valve and a brake unit.

### BACKGROUND ART

As one example of this kind of technique, there is a technique disclosed in a patent literature PTL 1, which will be listed below. PTL 1 discloses a normally-closed proportional solenoid valve characterized by a shape of a cavity portion thereof in which a plunger is slidably displaced, and a shape of the plunger along therewith. An iron core side of the cavity portion is formed into a stepped shape so as to taper with a radius thereof reducing toward a deepest bottom, and an iron core side of the plunger is also formed into a stepped shape so as to taper with a radius thereof reducing toward the deepest bottom. These shapes cause magnetic fluxes to flow in a radial direction by an increasing amount with respect to an amount of magnetic fluxes flowing in a direction in which the plunger is slidably displaced as the plunger is being further inwardly attracted, thereby preventing or reducing a change in a force for attracting the plunger, which otherwise would be caused according to how much a valve is opened.

### CITATION LIST

### Patent Literature

PTL 1: Japanese Patent Application Public Disclosure No. 2011-185306

### SUMMARY OF INVENTION

### Technical Problem

The invention discussed in PTL 1 is subject to such a problem that attraction efficiency is deteriorated due to the release of the magnetic fluxes in the radial direction, thereby leading to the necessity of increases in a size of a coil and power consumption.

The present invention has been made in consideration of the above-described problem, and an object thereof is to provide an electromagnetic valve and a brake unit capable of improving controllability while leading to no or a less increase in the size and no or less deterioration of the efficiency.

### Solution to Problem

To achieve the above-described object, a first aspect of the present invention is provided as an electromagnetic valve including a movable element configured to close a flow passage by abutting against a seat portion when being not actuated, a stator disposed at a position in an axial direction of the movable element, a coil configured to generate an electromagnetic force so as to cause a stroke of the movable element in a direction away from the seat portion, and a plate-shaped spring member configured to bias the movable element toward the seat portion.

A second aspect of the present invention is provided as an electromagnetic valve including a movable element configured to close a flow passage by abutting against a seat portion when being not actuated, a stator disposed at a position in an axial direction of the movable element, a coil configured to generate an electromagnetic force so as to cause a stroke of the movable element in a direction away from the seat portion, a first elastic member configured to bias the movable element toward the seat portion, and a second elastic member disposed in parallel with the first elastic member and configured to bias the movable element toward the seat portion, the second elastic member having a different characteristic from the first elastic member.

A third aspect of the present invention is provided as a brake unit including a housing including a hydraulic passage, in which brake fluid flows, configured to establish via the brake fluid a connection between a master cylinder configured to generate a brake hydraulic pressure based on a brake operation of a driver and a wheel cylinder provided on a wheel, and an electromagnetic valve fixed to the housing and configured to close and open the hydraulic passage. The electromagnetic valve includes a movable element configured to close the flow passage by abutting against a seat portion when being not actuated, a stator disposed at a position in an axial direction of the movable element, a coil configured to generate an electromagnetic force so as to cause a stroke of the movable element in a direction away from the seat portion, a plate-shaped spring member configured to bias the movable element toward the seat portion, and a coil spring disposed in parallel with the plate-shaped spring member and configured to bias the movable element toward the seat portion.

### Advantageous Effect of Invention

Therefore, the first to third aspects of the present invention can increase the efficiency of the attraction force while improving the controllability, thereby achieving a reduction in the size.

### BRIEF DESCRIPTION OF DRAWINGS

FIG. 1 illustrates a hydraulic circuit of a brake apparatus according to a first embodiment.

FIG. 2 is a cross-sectional view of a gate-out valve according to the first embodiment.

FIG. 3 illustrates a relationship between a stroke amount of a plunger and each of forces applied to the plunger according to the first embodiment.

FIG. 4 illustrates a relationship between the stroke amount of the plunger and an attraction force according to the first embodiment.

FIG. 5 illustrates a relationship between a size of a gap and efficiency of the attraction force according to the first embodiment.

FIG. 6 illustrates a hydraulic circuit of a brake apparatus according to another embodiment.

### DESCRIPTION OF EMBODIMENTS

### First Embodiment

A brake apparatus according to a first embodiment will be described now.

### [Configuration of Brake Hydraulic Circuit]

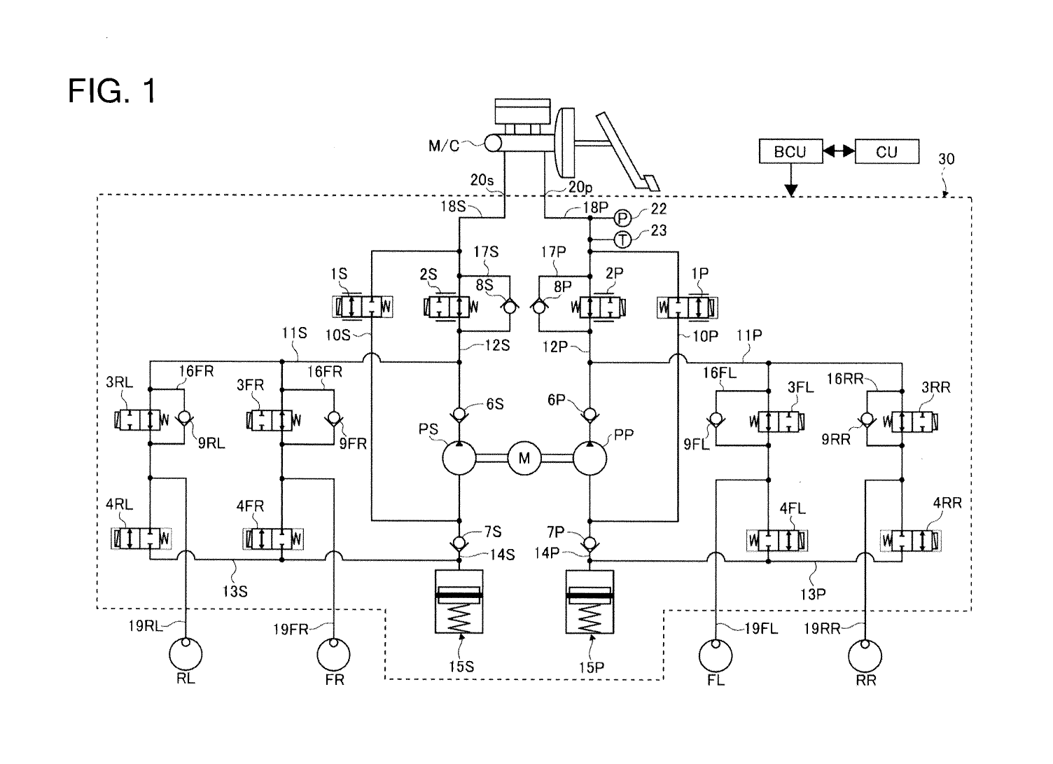

FIG. 1 illustrates a hydraulic circuit of the brake apparatus according to the first embodiment. The hydraulic circuit is formed in a hydraulic control unit 30 provided between a master cylinder M/C and wheel cylinders W/C. This hydraulic control unit 30 controls a hydraulic pressure according to a requested hydraulic pressure associated with regenerative cooperative control by an integrated controller CU that controls a running state of an entire vehicle, in addition to a requested hydraulic pressure of Vehicle Dynamics Control (hereinafter referred to as VDC) and Anti-lock Brake System (hereinafter referred to as ABS) from a brake controller BCU.

The hydraulic control unit 30 is configured as a piping structure that is a so-called X type dual circuit including two systems: a brake hydraulic circuit of a P system and a brake hydraulic circuit of an S system. A wheel cylinder W/C (FL) of a front left wheel and a wheel cylinder W/C (RR) of a rear right wheel are connected to the P system, and a wheel cylinder W/C (FR) of a front right wheel and a wheel cylinder W/C (RL) of a rear left wheel are connected to the S system.

The hydraulic control unit 30, and the individual wheel cylinders W/C are connected to wheel cylinder ports 19 (19RL, 19FR, 19FL, and 19RR) that are formed on an upper surface of a housing by holing this surface, respectively. Further, a pump unit is a tandem gear pump including a gear pump PP and a gear pump PS (hereinafter also collectively referred to as gear pumps P) for the P system and the S system, respectively, and configured to be driven by a motor M.

The master cylinder M/C and the hydraulic control unit 30 are connected to hydraulic passages 18P and 18S via master cylinder ports 20P and 20S that are formed on a port connection surface of the housing by holing this surface. These hydraulic passages 18, and intake sides of the gear pumps P are connected to each other via hydraulic passages 10P and 10S, respectively. Gate-in valves 1P and 1S, which are normally-closed solenoid valves, are provided in the hydraulic passages 10, respectively. A master cylinder pressure sensor 22 and a temperatures sensor 23 are provided in the hydraulic passage 18P between the master cylinder port 20P and a portion where the hydraulic passage 18P is connected to the hydraulic passage 10P.

Discharge sides of the gear pumps P, and the individual wheel cylinders W/C are connected to each other via hydraulic passages 11P and 11S, respectively. Pressure increase valves 3FL and 3RR, and 3FR and 3RL, which are individual normally-opened solenoid valves corresponding to the wheel cylinders W/C, respectively, are provided in these individual hydraulic passages 11, respectively. Further, check valves 6P and 6S are provided in the individual hydraulic passages 11 between the individual pressure increase valves 3 and the pump units P, respectively. Each of the check valves 6 permits a brake hydraulic pressure to flow in a direction from the gear pump P to the pressure increase valve 3, but prohibits the brake hydraulic pressure from flowing in an opposite direction.

Further, hydraulic passages 16FL and 16RR, and 16FR and 16RL, which bypass the individual pressure increase valves 3, respectively, are provided in the individual hydraulic passages 11, respectively. Check valves 9FL 9RR, 9FR, and 9RL, are provided in the hydraulic passages 16, respectively. Each of these check valves 9 permits the brake hydraulic pressure to flow in a direction from the wheel cylinder W/C to the master cylinder M/C, but prohibits the brake hydraulic pressure from flowing in an opposite direction.

The master cylinder M/C and the hydraulic passages 11 are connected to each other via hydraulic passages 129 and 12S, respectively, and each of the hydraulic passages 11 and its corresponding one of the hydraulic passages 12 join together between the gear pump P and the pressure increase valves 3. Gate-out valves 2P and 2S, which are normally-opened solenoid valves, are provided in these individual hydraulic passages 12, respectively. Further, hydraulic passages 17P and 17S, which bypass the individual gate-out valves 2, respectively, are provided in the individual hydraulic passages 12, respectively. Check valves 8P and 8S are provided in these hydraulic passages 17, respectively. Each of these check valves 8 permits the brake hydraulic pressure to flow in a direction from a master cylinder side where the master cylinder M/C is located to the wheel cylinder W/C, but prohibits the brake hydraulic pressure from flowing in an opposite direction.

Reservoirs 15P and 15a are provided on the intake sides of the gear pumps P, respectively, and these reservoirs 15 and the gear pumps P are connected to each other via hydraulic passages 14P and 14S, respectively. Check valves 7P and 7S are provided between the reservoirs 15 and the gear pumps P, respectively. The wheel cylinders W/C and the hydraulic passages 14 are connected to each other via the hydraulic passages 13, respectively, and each of the hydraulic passages 13 and its corresponding one of the hydraulic passages 14 join together between the check valve 7 and the reservoir 5. Pressure reduction valves 4FL and 4RR, 4FR and 4RL, which are normally-closed solenoid valves, are provided in these individual hydraulic passages 13, respectively.

When a request to increase the hydraulic pressure is issued to the wheel cylinder of a certain wheel, for example, during the VDC control, the gate-in valve 1, the gate-out valve 2, the pressure increase valve 3, and the pressure reduction valve 4 are opened, closed, opened, and closed, respectively, and the gear pump P is driven. These operations allow the gear pump P to introduce the brake fluid from the master cylinder M/C via the gate-in valve 1 and to discharge the brake fluid to increase a pressure in the wheel, cylinder, which realizes vehicle stability control. Further, when the requested hydraulic pressure associated with the regenerative cooperative control is set from the integrated controller CU, the pressure increase valve 3 and the pressure reduction valve 4 which correspond to the wheel cylinder of a driving wheel are closed and opened, respectively, to reduce the pressure therein, and the gear pump P is driven, by which the brake fluid stored in the reservoir 15 is returned to the master cylinder side. At this time, a pedal feeling is prevented from being deteriorated by execution of balance control on the gate-out valve 2.

[Configuration of Gate-Out Valve]

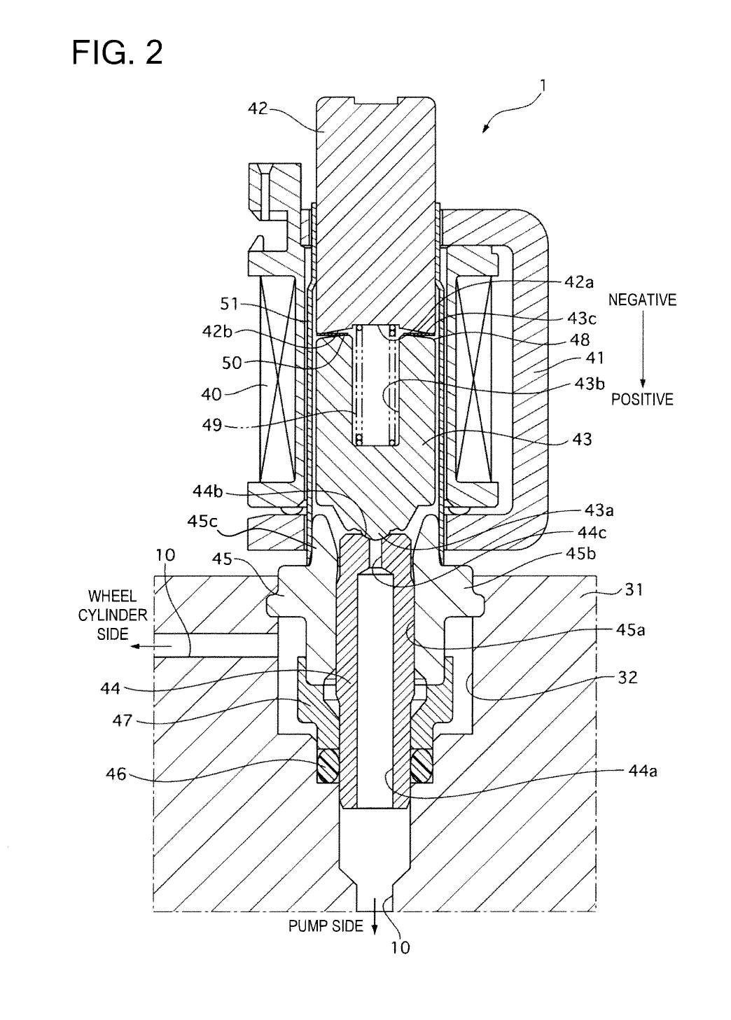

FIG. 2 is a cross-sectional view of the gate-in valve 1. The gate-in valve 1 includes a coil 40, an armature 42, a plunger 43, a seat valve 44, and a valve body 45. The coil 40 generates an electromagnetic force upon power supply thereto. The armature 42 is disposed inside a yolk 41 containing the coil 40 therein. The plunger 43 is driven by the electromagnetic force. The seat valve 44 is hollowly formed. The valve boy 45 contains the seat valve 44 therein.

In the following description, an axial direction is defined to be a direction in which the plunger 43 is slidably displaced. A positive side in the axial direction is defined to be a direction in which the plunger 43 is displaced in a valve-closing direction when no power is supplied to the coil 40. A negative side in the axial direction is defined to be a direction in which the plunger 43 is displaced in a valve-opening direction when power is supplied to the coil 40.

A valve insertion portion 32, where the gate-in valve 1 is inserted, is formed on the way in the hydraulic passage 10 formed in a housing 31 of the hydraulic control unit 30. A seal member 46, a cup member 47, the seat valve 44, and the valve body 45 are inserted in this valve insertion portion 32 in this order, and the valve body 45 is swaged and fixed by the housing 31.

A seat surface 44b is formed into a semicircular concaved shape on the negative side of the seat valve 44 in the axial direction. A valve element 43a of the plunger 43, which will be described below, is seated on the seat surface 44b when the valve is closed. An outer peripheral surface of the seat surface 44b is connected to the master cylinder M/C of the hydraulic passage 10 via a not-illustrated hydraulic passage. A penetrating hydraulic passage 44a is formed by holing the seat valve 44 so as to axially extend from the positive side of the seat valve 44 in the axial direction. The penetrating hydraulic passage 44a is connected to a portion of the hydraulic passage 10 that is closer to the pump P. A seat bore 44c, which is in communication with the penetrating hydraulic passage 44a and the seat surface 44b, is formed by holing the seat valve 44 on the negative side of the penetrating hydraulic passage 44a in the axial direction.

The valve body 45 includes a seat valve containing hole 45a penetrating through an axis of the valve body 45 in the axial direction. The seat valve 44 is press-fitted in the seat valve containing hole 45a. A swaged portion 45b, which is formed into a stepped shape, is formed on an outer periphery of the valve body 45. The housing 31 is swaged to the swaged portion 45b by being plastically deformed. A cylindrical member press-fitted portion 45c, which is sized so as to be smaller in diameter than the swaged portion 45b, is formed on the negative side of the swaged portion 45b in the axial direction. A cylindrical member 51, which will be described below, is fixed to the cylindrical member press-fitted portion 45c by being press-fitted thereto.

The cylindrical member 51 is made of a non-magnetic body and is cylindrically formed. The armature 42 and the plunger 43 are inserted on an inner periphery of the cylindrical member 51. The armature 42 is fixed to the cylindrical member, and the plunger 43 is contained therein displaceably in the axial direction. The armature 42 and the plunger 43 are disposed in such a manner that a gap 48 is generated therebetween when no power is supplied to the coil 40.

The armature 42 is made of a magnetic member and is formed into a columnar shape. When power is supplied to the coil 40, the armature 42 generates the electromagnetic force for attracting the plunger 43 in the valve-opening direction. A columnar recessed coil spring support portion 42a is formed at a center of a shaft of the armature 42 on an end surface of the armature 42 on the positive side in the axial direction. A recessed inclined surface 42b is formed on the end surface of the armature 42 on the positive side in the axial direction. The recessed inclined surface 42b is recessed from an edge of an outer periphery of the armature 42 toward an edge of the coil spring support portion 42a, defining a truncated conical shape.

The plunger 43 is made of a magnetic member. The positive side of the plunger 43 in the axial direction bulges into a generally conical shape, and the generally hemisphere-shaped valve element 43a is formed at a top thereof. A coil spring containing hole 43b is formed at an axis of the plunger 43 on the negative side of the plunger 43 in the axial direction by holing the plunger 43 in the axial direction. A coil spring 49 is set while being compressed in the coil spring containing hole 43b and the coil spring support portion 42a of the armature 42. The coil spring 49 biases the plunger 43 toward the positive side in the axial direction, i.e., biases the plunger 43 in the valve-closing direction. A protruding inclined surface 43c is formed on the negative side of the plunger 43 in the axial direction. The protruding inclined surface 43c bulges into a truncated conical shape from an edge of the coil spring containing hole 43b to an edge of an outer periphery of the plunger 43. A plate spring 50 is provided between the protruding inclined surface 43c and the recessed inclined surface 42b of the armature 42.

The plate spring 50 is a metallic member shaped as an annular flat plate. When power is supplied to the coil 40, an inner peripheral portion of the plate spring 50 is deformed as the plunger 43 is displaced toward the negative side in the axial direction, thereby biasing the plunger 43 toward the positive side in the axial direction. In other words, the plate spring 50 biases the plunger 43 in the valve-closing direction. The plate spring 50 is set so as not to be deformed with no power supplied to the coil 40 and the valve element 43a of the plunger 43 seated on the seat surface 44b of the seat valve 44, thereby being arranged so as not to generate the biasing force of the plate spring 50 at this time. In other words, the plate sprint 50 is provided in such a manner that a setting load of the plate spring 50 is lower than a setting load of the above-described coil spring 49.

[Forces Applied to Plunger]

A force applied to the plunger 43 by a spring force of the coil spring 49 and a force applied to the plunger 43 by a spring force of the plate spring 50 are set in the following manner.

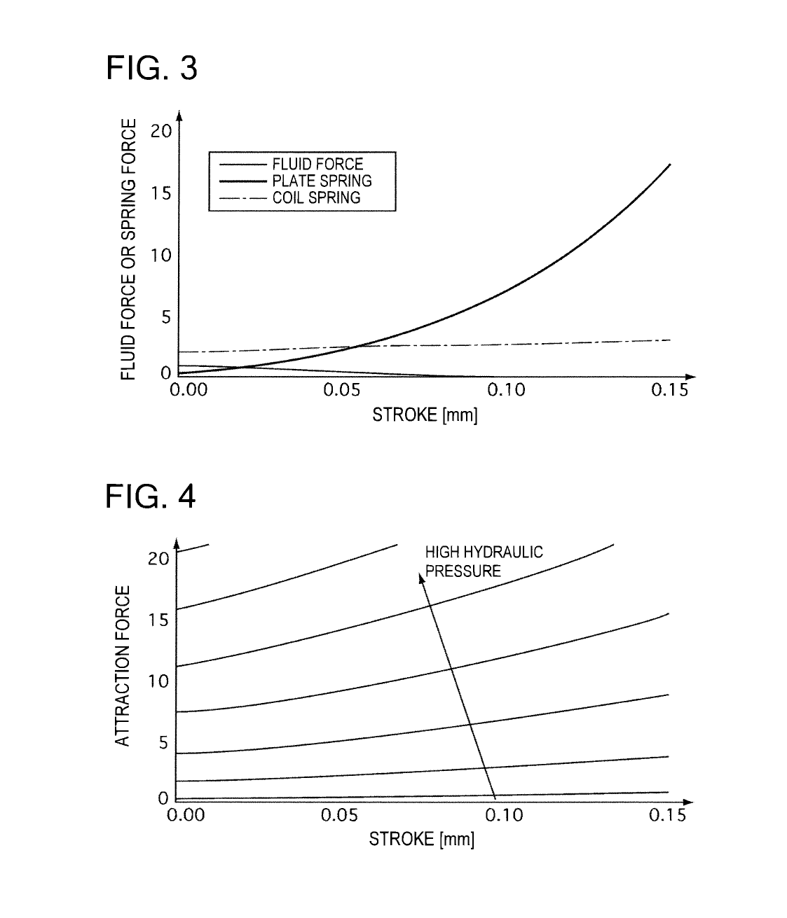

FIG. 3 illustrates a relationship between a stroke amount of the plunger 43 and each of forces applied to the plunger 43. FIG. 3 illustrates a force applied due to the brake fluid (a fluid force), the spring force of the plate spring 50, and the spring force of the coil spring 49. As will be used herein, the stroke amount refers to how much the plunger 43 is pulled up from a state in which the valve element 43a is seated on the seat surface 44b.

As illustrated in FIG. 3, the fluid force is slightly applied when a valve-opening amount is small but is lost when the valve-opening amount increases. The spring force of the plate spring 50 is set so as to exponentially increase as the valve-opening amount increases. The spring force of the coil spring 49 is set so as to increase as the valve-opening amount increases but keep a generally constant strength. The gate-in valve 1 is set in such a manner that the spring force applied to the plunger 43 by the coil spring 49 is greater than the spring force applied to the plunger 43 by the plate sprint 50 when the stroke amount is smaller than a predetermined stroke amount (approximately 0.05 [mm]), and the spring force applied to the plunger 43 by the plate spring 50 is greater than the spring force applied to the plunger 43 by the coil spring 49 when the stroke amount is equal to or larger than the predetermined stroke. Further, a change amount of the spring force of the plate spring 50 per unit stroke amount is set to a larger amount than a change amount of the spring force of the coil spring 49 per unit stroke amount. In other words, spring coefficients of the coil spring 49 and the plate spring 50 are set so as to be different from each other.

[Function]

It is preferable that a spring force of an elastic member biasing the plunger 43 in the valve-closing direction is approximately equivalent to an attraction force between the armature 42 and the plunger 43 that is applied to the plunger 43 in the valve-opening direction from the viewpoint of control of the valve-opening amount of the gate-in valve 1. If the spring force of the elastic member is extremely weak, this makes it difficult to control the valve-opening amount, thereby deteriorating precision of the valve-opening amount.

FIG. 4 illustrates a relationship between the stroke amount of the plunger 43 and the attraction force. FIG. 4 illustrates the relationship per hydraulic pressure on the master cylinder M/C side of the hydraulic passage 10. FIG. 4 illustrates the relationship with a width of the gap 48 kept to a predetermined value when no power is supplied to the coil 40. As illustrated in FIG. 4, the attraction force between the armature 42 and the plunger 43 increases as the stroke amount of the plunger 43 increases. In other words, the attraction force increases as a distance between the armature 42 and the plunger 43 reduces. Further, as illustrated in FIG. 4, the attraction force increases as the hydraulic pressure increases on the master cylinder M/C side of the hydraulic passage 10.

Since the attraction force between the armature 42 and the plunger 43 increases as the stroke amount of the plunger 43 increases as described above, the spring force of the elastic member should increase as the stroke amount increases. The spring force of the coil spring 49 changes by only a small amount per unit stroke amount of the plunger 43 as illustrated in FIG. 3. Therefore, use of the coil spring 49 alone as the elastic member leads to the necessity of the stroke amount to achieve the increase in the spring force of the coil spring 49, thereby leading to the necessity of setting the width of the gap 48 to a wide width.

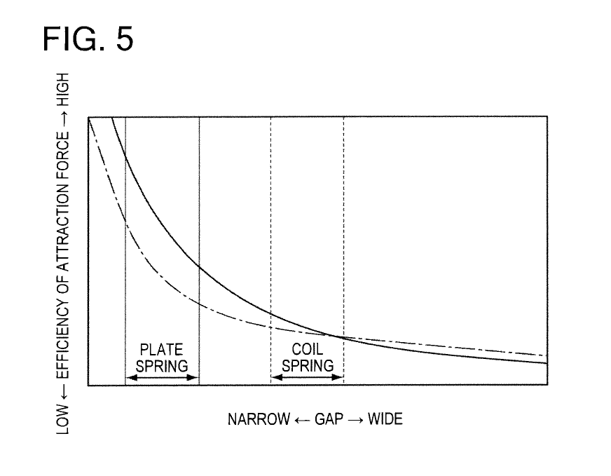

FIG. 5 illustrates a relationship between the size of the gap 48 and efficiency of the attraction force. A solid line and a chain line illustrated in FIG. 5 represent an efficiency line of the plate spring 50 and an efficiency line of the coil spring, respectively. The efficiency of the attraction force refers to a force for attracting the plunger 43 per unit energy generated by the coil 40 (an electric current x the number of turns of the coil 40 [AT]). As illustrated in FIG. 5, the efficiency of the attraction force reduces as the size of the gap 48 increases.

For example, suppose that the gate-in valve 1 is controlled from a closed state within a range of an extremely small opening degree. Since the use of the coil spring 49 alone as the elastic member leads to the necessity of setting the width of the gap 48 to the wide width as described above, the use of the coil spring 49 alone results in controlling the gate-in valve 1 in a range where the efficiency of the attraction force is low when controlling the gate-in valve 1 from the closed state within the range of the extremely small opening degree. The efficiency of the attraction force with the valve closed is 0.0078[N/AT], when the coil spring 49 is used alone as the elastic member. The low efficiency of the attraction force leads to the necessity of increasing the attraction force by, for example, sizing up the coil 40 to enhance the electromagnetic force.

Therefore, in the first embodiment, the plate spring 50 is used as the elastic member. The spring force of the plate spring 50 is weak when the stroke amount of the plunger 43 is small, but is changeable with a large change amount with respect to the unit stroke amount, which allows the width of the gap 48 to be set to a narrow width. In other words, as illustrated in FIG. 5, the use of the plate spring 50 results in controlling the gate-in valve 1 in a range where the efficiency of the attraction force is high when controlling the gate-in valve 1 from the closed state within the range of the extremely small opening degree. The efficiency of the attraction force with the valve closed is 0.0132[N/AT] when the plate spring 50 is used alone as the elastic member.

In the first embodiment, the plate spring 50 is provided between the armature 42 and the plunger 43. This provision eliminates the necessity of especially forming, for example, a portion for containing the plate spring 50, thereby contributing to simplification of the configuration of the gate-in valve 1.

In the first embodiment, the coil spring 49, which biases the plunger 43 toward the seat surface 44b, is provided in parallel with the plate sprint 50. Since the change amount of the spring force of the coil spring 49 is small with respect to the unit stroke amount, combining the plate spring 50 and the coil spring 49 can enhance the spring force as a whole while maintaining the characteristic about the change amount of the spring force of the coil spring 49 with respect to the stroke. Therefore, the first embodiment can secure the spring force even when the stroke amount is small, thereby improving controllability of the gate-in valve 1.

In the first embodiment, the spring coefficients of the coil spring 49 and the plate spring 50 are set so as to be different from each other. By this setting, the first embodiment can secure the efficiency of the attraction force while acquiring a high spring coefficient.

In the first embodiment, the setting load of the plate spring 50 is set to the lower load than the setting load of the coil spring 49. The first embodiment can enhance the spring force of the coil spring 49 and therefore enhance the spring force as a whole, thus improving the controllability of the gate-in valve 1.

In the first embodiment, the gate-in valve 1 is set in such a manner that the spring force applied to the plunger 43 by the coil spring 49 is greater than the spring force applied to the plunger 43 by the plate sprint 50 when the stroke of the plunger 43 is shorter than the predetermined stroke amount, and the spring force applied to the plunger 43 by the plate spring 50 is greater than the spring force applied to the plunger 43 by the coil spring 49 when the stroke of the plunger 43 is equal to or longer than the predetermined stroke amount. By this setting, the first embodiment can prevent the spring force from becoming excessively strong even with the coil spring 49 and the plate spring 50 combined with each other when the stroke amount is small and the attraction force between the armature 42 and the plunger 43 is weak, thereby improving the controllability of the gate-in valve 1.

In the first embodiment, the change amount of the spring force of the plate spring 50 per unit stroke amount is set to the larger amount than the change amount of the spring force of the coil spring 49 per unit stroke amount. By this setting, the first embodiment can increase the spring force with the aid of the plate spring 50 when the stroke amount is large and the attraction force between the armature 42 and the plunger 43 is great, thereby improving the controllability of the gate-in valve 1.

### Advantageous Effects

(1) The gate-in valve 1 includes the plunger 43 (the movable element) configured to close the flow passage by abutting against the seat surface 44b (a seat portion) of the seat valve 44 when being not actuated, the armature 42 (a stator) disposed at the position in the axial direction of the plunger 43, the coil 40 configured to generate the electromagnetic force so as to cause the stroke of the plunger 43 in the direction away from the seat surface 44b, and the plate spring 50 (a plate-shaped spring member) configured to bias the plunger 43 toward the seat surface 44b.

Therefore, the first embodiment can increase the efficiency of the attraction force while improving the controllability, thereby achieving a reduction in the size of the coil 40.

(2) The plate spring 50 is set while being compressed between the one end side of the plunger and the opposite end side of the armature 42.

Therefore, the first embodiment can simplify the configuration of the gate-in valve 1.

(3) The gate-in valve 1 further includes the coil spring 49 configured to bias the plunger 43 toward the seat surface 44b in parallel with the plate spring 50.

Therefore, the first embodiment can improve the controllability of the gate-in valve 1.

(4) The coil spring 49 has the different spring coefficient from the plate spring 50.

Therefore, the first embodiment can secure the efficiency of the attraction force while acquiring the high spring coefficient.

(5) The setting load of the plate spring 50 is set to the lower load than the setting load of the coil spring 49.

Therefore, the first embodiment can improve the controllability of the gate-in valve 1.

(6) The gate-in valve 1 is configured in such a manner that the spring force applied to the plunger 43 by the coil spring 49 is greater than the spring force applied to the plunger 43 by the plate spring 50 when the stroke of the plunger 43 is shorter than the predetermined stroke amount, and the spring force applied to the plunger 43 by the plate spring 50 is greater than the spring force applied to the plunger 43 by the coil spring 49 when the stroke of the plunger 43 is equal to or longer than the predetermined stroke amount.

Therefore, the first embodiment can improve the controllability of the gate-in valve 1.

(7) The change amount of the spring force of the plate spring 50 per unit stroke amount is set to the larger amount than the change amount of the spring force of the coil spring 49 per unit stroke amount.

Therefore, the first embodiment can improve the controllability of the gate-in valve 1.

(8) The gate-in valve 1 includes the plunger 43 (the movable element) configured to close the flow passage by abutting against the seat surface 44b (the seat portion) of the seat valve 44 when being not actuated, the armature 42 (the stator) disposed at the position in the axial direction of the plunger 43, the coil 40 configured to generate the electromagnetic force so as to cause the stroke of the plunger 43 in the direction away from the seat surface 44b, the plate spring 50 (a first elastic member) configured to bias the plunger 43 toward the seat surface 44b, and the coil spring 49 (a second elastic member) disposed in parallel with the plate spring 50, configured to bias the plunger 43 toward the seat surface 44b, and having the different characteristic from the plate spring 50.

Therefore, the first embodiment can increase the efficiency of the attraction force while improving the controllability, thereby achieving the reduction in the size of the coil 40.

(9) The hydraulic control unit 30 (a brake unit) includes the housing 31 including the hydraulic passage 10, in which the brake fluid flows, configured to establish via the brake fluid the connection between the master cylinder M/C configured to generate the brake hydraulic pressure based on a brake operation of a driver and the wheel cylinder W/C provided on the wheel, and the gate-in valve 1 (an electromagnetic valve) fixed to the housing 31 and configured to close and open the hydraulic passage 10. The gate-in valve 1 includes the plunger 43 (the movable element) configured to close the flow passage by abutting against the seat surface 44b (the seat portion) of the seat valve 44 when being not actuated, the armature 42 (the stator) disposed at the position in the axial direction of the plunger 43, the coil 40 configured to generate the electromagnetic force so as to cause the stroke of the plunger 43 in the direction away from the seat surface 44b, the plate spring 50 (the plate-shaped spring member) configured to bias the plunger 43 toward the seat surface 44b, and the coil spring 49 disposed in parallel with the plate spring 50 and configured to bias the plunger 43 toward the seat surface 44b.

Therefore, the first embodiment can increase the efficiency of the attraction force while improving the controllability, thereby achieving the reduction in the size of the coil 40.

### OTHER EMBODIMENTS

Having described the present invention based on the first embodiment, the specific configuration of each invention is not limited to the first embodiment, and the present invention includes even a design modification and the like made within a range that does not depart from the spirit of the present invention.

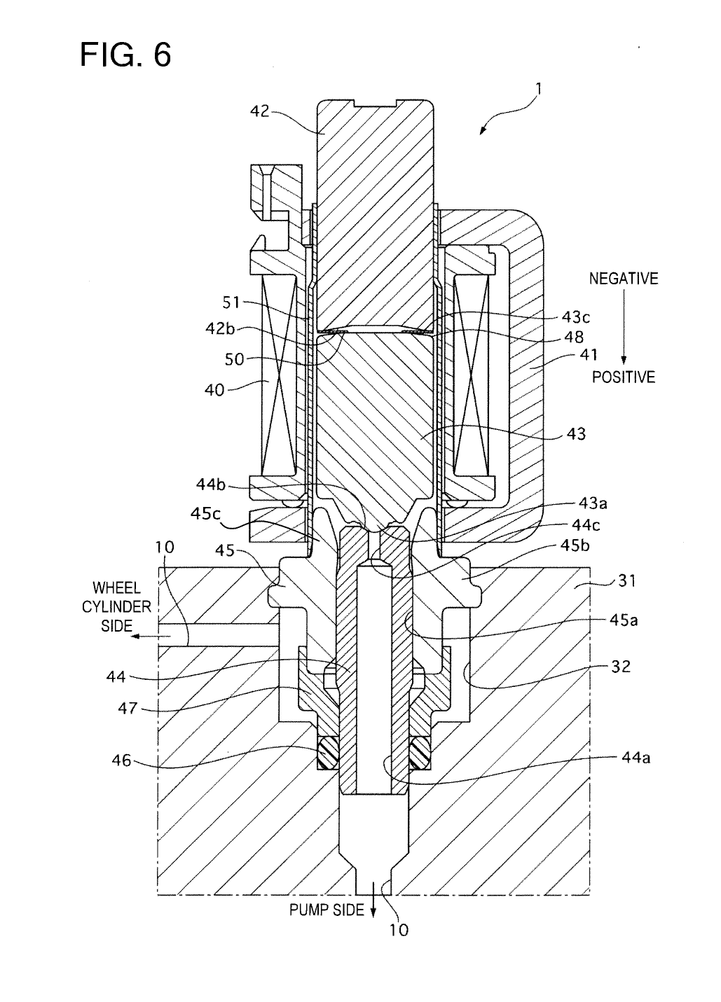

FIG. 6 is a cross-sectional view of the gate-in valve 1. In the first embodiment, the gate-in valve 1 is configured in such a manner that the plunger 43 is biased in the valve-closing direction by the coil spring 49 and the plate spring 50, but may be configured in such a manner that the plunger 43 is biased in the valve-closing direction with use of the plate spring 50 alone.

Further, technical ideas recognizable from the above-described embodiment will be listed below.

(1) An electromagnetic valve includes a movable element configured to close a flow passage by abutting against a seat portion when being not actuated, a stator disposed at a position in an axial direction of the movable element, a coil configured to generate an electromagnetic force so as to cause a stroke of the movable element in a direction away from the seat portion, and a plate-shaped spring member configured to bias the movable element toward the seat portion.
(2) The electromagnetic valve described in the above-described item (1) further includes an elastic member configured to bias the movable element toward the seat portion in parallel with the plate-shaped spring member.
(3) In the electromagnetic valve described in the above-described item (2), the elastic member is a coil spring and has a different spring coefficient from the plate-shaped spring member.
(4) In the electromagnetic valve described in the above-described item (3), a setting load of the plate-shaped spring member is lower than a setting load of the coil spring.
(5) In the electromagnetic valve described in the above-described item (3), the electromagnetic valve is configured in such a manner that a spring force applied to the movable element by the coil spring is greater than a spring force applied to the movable element by the plate-shaped spring member when the stroke of the movable element is shorter than a predetermined stroke amount, and the spring force applied to the movable element by the plate-shaped spring member is greater than the spring force applied to the movable element by the coil spring when the stroke of the movable element is equal to or longer than the predetermined stroke amount.
(6) In the electromagnetic valve described in the above-described item (3), a change amount of a spring force of the plate-shaped spring member per unit stroke amount is larger than a change amount of a spring force of the coil spring per unit stroke amount.
(7) In the electromagnetic valve described in the above-described item (1), the plate-shaped spring member is set while being compressed between one end side of the movable element and an opposite end side of the stator.
(8) In the electromagnetic valve described in the above-described item (1), the stator is disposed on one end side of the movable element. The electromagnetic valve further includes a valve element provided on an opposite end side of the movable element and configured to close the flow passage by being seated on the seat portion, and a body disposed on the opposite end side of the movable element and integrally fixed to the seat portion and the stator. The plate-shaped spring member is set while being compressed between the opposite end side of the movable element and the body.
(9) An electromagnetic valve includes a movable element configured to close a flow passage by abutting against a seat portion when being not actuated, a stator disposed at a position in an axial direction of the movable element, a coil configured to generate an electromagnetic force so as to cause a stroke of the movable element in a direction away from the seat portion, a first elastic member configured to bias the movable element toward the seat portion, and a second elastic member disposed in parallel with the first elastic member and configured to bias the movable element toward the seat portion. The second elastic member has a different characteristic from the first elastic member.
(10) In the electromagnetic valve described in the above-described item (9), the first elastic member is a plate-shaped spring member, and the second elastic member is a coil spring.
(11) In the electromagnetic valve described in the above-described item (9), the first elastic member is set while being compressed between one end side of the movable element and an opposite end side of the stator.
(12) In the electromagnetic valve described in the above-described item (9), a setting load of the first elastic member is lower than a setting load of the second elastic member.
(13) In the electromagnetic valve described in the above-described item (11), the electromagnetic valve is configured in such a manner that a spring force applied to the movable element by the second elastic member is greater than a spring force applied to the movable element by the first elastic member when the stroke of the movable element is shorter than a predetermined stroke amount, and the spring force applied to the movable element by the first elastic member is greater than the spring force applied to the movable element by the second elastic member when the stroke of the movable element is equal to or longer than the predetermined stroke amount.
(14) In the electromagnetic valve described in the above-described item (13), the first elastic member is a plate-shaped spring member, and the second elastic member is a coil spring.
(15) In the electromagnetic valve described in the above-described item (12), a change amount of a spring force of the first elastic member per unit stroke amount is larger than a change amount of a spring force of the second elastic member per unit stroke amount.
(16) A brake unit includes a housing including a hydraulic passage, in which the brake fluid flows, configured to establish via brake fluid a connection between a master cylinder configured to generate a brake hydraulic pressure based on a brake operation of a driver and a wheel cylinder provided on a wheel, and an electromagnetic valve fixed to the housing and configured to close and open the hydraulic passage. The electromagnetic valve includes a movable element configured to close the flow passage by abutting against a seat portion when being not actuated, a stator disposed at a position in an axial direction of the movable element, a coil configured to generate an electromagnetic force so as to cause a stroke of the movable element in a direction away from the seat portion, a plate-shaped spring member configured to bias the movable element toward the seat portion, and a coil spring disposed in parallel with the plate-shaped spring member and configured to bias the movable element toward the seat portion.
(17) In the brake unit described in the above-described item (16), the electromagnetic valve is configured in such a manner that a spring force applied to the movable element by the coil spring is greater than a spring force applied to the movable element by the plate-shaped spring member when the stroke of the movable element is shorter than a predetermined stroke amount, and the spring force applied to the movable element by the plate-shaped spring member is greater than the spring force applied to the movable element by the coil spring when the stroke of the movable element is equal to or longer than the predetermined stroke amount.
(18) In the brake unit described in the above-described item (16), a setting load of the plate-shaped spring member is lower than a setting load of the coil spring.
(19) In the brake unit described in the above-described item (16), a change amount of a spring force of the plate-shaped spring member per unit stroke amount is larger than a change amount of a spring force of the coil spring per unit stroke amount.

This application claims priority to Japanese Patent Application No. 2013-256959 filed on Dec. 12, 2013. The entire disclosure of Japanese Patent Application No. 2013-256959 filed on Dec. 12, 2013 including the specification, the claims, the drawings, and the summary is incorporated herein by reference in its entirety.

### REFERENCE SIGNS LIST

1 gate-out valve (electromagnetic valve)
10 hydraulic passage
30 hydraulic control unit (brake unit)
31 housing
40 coil
42 armature (stator)
43 plunger (movable element)
44b seat surface (seat portion)
49 coil spring
50 plate spring (plate-shaped spring member)
M/C master cylinder
W/C wheel cylinder

1. An electromagnetic valve comprising:
a movable element configured to close a flow passage by abutting against a seat portion when being not actuated;
a stator disposed at a position in an axial direction of the movable element;
a coil configured to generate an electromagnetic force so as to cause a stroke of the movable element in a direction away from the seat portion; and
a plate-shaped spring member configured to bias the movable element toward the seat portion.

2. The electromagnetic valve according to claim 1, further comprising an elastic member configured to bias the movable element toward the seat portion in parallel with the plate-shaped spring member.

3. The electromagnetic valve according to claim 2, wherein the elastic member is a coil spring and has a different spring coefficient from the plate-shaped spring member.

4. The electromagnetic valve according to claim 3, wherein a setting load of the plate-shaped spring member is lower than a setting load of the coil spring.

5. The electromagnetic valve according to claim 3, wherein the electromagnetic valve is configured in such a manner that a spring force applied to the movable element by the coil spring is greater than a spring force applied to the movable element by the plate-shaped spring member when the stroke of the movable element is shorter than a predetermined stroke amount, and the spring force applied to the movable element by the plate-shaped spring member is greater than the spring force applied to the movable element by the coil spring when the stroke of the movable element is longer than the predetermined stroke amount.

6. The electromagnetic valve according to claim 3, wherein a change amount of a spring force of the plate-shaped spring member per unit stroke amount is larger than a change amount of a spring force of the coil spring per unit stroke amount.

7. The electromagnetic valve according to claim 1, wherein the plate-shaped spring member is set while being compressed between one end side of the movable element and an opposite end side of the stator.

8. The electromagnetic valve according to claim 1, wherein the stator is disposed on one end side of the movable element,
wherein the electromagnetic valve further comprises a valve element provided on an opposite end side of the movable element and configured to close the flow passage by being seated on the seat portion, and a body disposed on the opposite end side of the movable element and integrally fixed to the seat portion and the stator, and
wherein the plate-shaped spring member is set while being compressed between the opposite end side of the movable element and the body.

9. An electromagnetic valve comprising:
a movable element configured to close a flow passage by abutting against a seat portion when being not actuated;
a stator disposed at a position in an axial direction of the movable element;
a coil configured to generate an electromagnetic force so as to cause a stroke of the movable element in a direction away from the seat portion;
a first elastic member configured to bias the movable element toward the seat portion; and
a second elastic member disposed in parallel with the first elastic member and configured to bias the movable element toward the seat portion, the second elastic member having a different characteristic from the first elastic member.

10. The electromagnetic valve according to claim 9, wherein the first elastic member is a plate-shaped spring member, and the second elastic member is a coil spring.

11. The electromagnetic valve according to claim 9, wherein the first elastic member is set while being compressed between one end side of the movable element and an opposite end side of the stator.

12. The electromagnetic valve according to claim 9, wherein a setting load of the first elastic member is lower than a setting load of the second elastic member.

13. The electromagnetic valve according to claim 11, wherein the electromagnetic valve is configured in such a manner that a spring force applied to the movable element by the second elastic member is greater than a spring force applied to the movable element by the first elastic member when the stroke of the movable element is shorter than a predetermined stroke amount, and the spring force applied to the movable element by the first elastic member is greater than the spring force applied to the movable element by the second elastic member when the stroke of the movable element is longer than the predetermined stroke amount.

14. The electromagnetic valve according to claim 13, wherein the first elastic member is a plate-shaped spring member, and the second elastic member is a coil spring.

15. The electromagnetic valve according to claim 12, wherein a change amount of a spring force of the first elastic member per unit stroke amount is larger than a change amount of a spring force of the second elastic member per unit stroke amount.

16. A brake unit comprising:
a housing including a hydraulic passage, in which the brake fluid flows, configured to establish via brake fluid a connection between a master cylinder configured to generate a brake hydraulic pressure based on a brake operation of a driver and a wheel cylinder provided on a wheel; and
an electromagnetic valve fixed to the housing and configured to close and open the hydraulic passage,
the electromagnetic valve including
a movable element configured to close the flow passage by abutting against a seat portion when being not actuated,
a stator disposed at a position in an axial direction of the movable element,
a coil configured to generate an electromagnetic force so as to cause a stroke of the movable element in a direction away from the seat portion,
a plate-shaped spring member configured to bias the movable element toward the seat portion, and
a coil spring disposed in parallel with the plate-shaped spring member and configured to bias the movable element toward the seat portion.

17. The brake unit according to claim 16, wherein the electromagnetic valve is configured in such a manner that a spring force applied to the movable element by the coil spring is greater than a spring force applied to the movable element by the plate-shaped spring member when the stroke of the movable element is shorter than a predetermined stroke amount, and the spring force applied to the movable element by the plate-shaped spring member is greater than the spring force applied to the movable element by the coil spring when the stroke of the movable element is longer than the predetermined stroke amount.

18. The brake unit according to claim 16, wherein a setting load of the plate-shaped spring member is lower than a setting load of the coil spring.

19. The brake unit according to claim 16, wherein a change amount of a spring force of the plate-shaped spring member per unit stroke amount is larger than a change amount of a spring force of the coil spring per unit stroke amount.
